(19) United States
(12) Patent Application Publication
(10) Pub. No.: US 2025/0192344 A1
(43) Pub. Date: Jun. 12, 2025

(54) BATTERY VENT EXIT PATH CONCEPTS FOR TRACTION BATTERY PACKS

(71) Applicant: FORD GLOBAL TECHNOLOGIES, LLC, Dearborn, MI (US)

(72) Inventors: Joseph Fricano, Canton, MI (US); Karen Siler, Commerce Township, MI (US)

(21) Appl. No.: 18/966,802

(22) Filed: Dec. 3, 2024

Related U.S. Application Data
(60) Provisional application No. 63/607,888, filed on Dec. 8, 2023.

(51) Int. Cl. H01M 50/342; H01M 10/625; H01M 10/6554; H01M 50/211; H01M 50/249; H01M 50/367

(52) U.S. Cl. CPC H01M 50/3425; H01M 10/625; H01M 10/6554; H01M 50/211; H01M 50/249; H01M 50/367; H01M 2220/20

(57) ABSTRACT

Vent path management concepts are provided for traction battery packs. An exemplary traction battery pack may include a vent gas exit path that extends beneath a heat exchanger plate of the traction battery pack. During a battery thermal event, battery vent byproducts released by one or more battery cells of a cell stack of the traction battery pack may be directed through exposed openings of the heat exchanger plate and then into the vent gas exit path. The battery vent byproducts may flow away from high voltage components of the cell stack within the vent gas exit path prior to being expelled from the traction battery pack. The openings of the heat exchanger plate may be sealed by barrier sheets during normal battery operating conditions.

### CROSS-REFERENCE TO RELATED APPLICATIONS

This disclosure claims the benefit of U.S. Provisional Application No. 63/607,888, which was filed on Dec. 8, 2023 and is incorporated herein by reference in its entirety.

### TECHNICAL FIELD

This disclosure relates generally to traction battery packs, and more particularly to vent path management concepts that involve directing battery vent byproducts beneath a heat exchanger plate of a traction battery pack during battery thermal events.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a battery cell stack, a heat exchanger plate including a vent opening, and a barrier sheet received within the vent opening. The barrier sheet is configured to dislodge from the vent opening or otherwise plastically deform and thereby expose the vent opening in response to a flow of a battery vent byproduct against the barrier sheet.

In a further non-limiting embodiment of the foregoing traction battery pack, the barrier sheet is a mica sheet.

In a further non-limiting embodiment of either of the foregoing traction battery packs, the barrier sheet includes a frame portion and a pocket portion.

In a further non-limiting embodiment of any of the foregoing traction battery packs, the frame portion extends within a plane that is vertically higher than a floor of the pocket portion.

In a further non-limiting embodiment of any of the foregoing traction battery packs, the pocket portion is sized to receive a fin of a battery cell of the battery cell stack.

In a further non-limiting embodiment of any of the foregoing traction battery packs, the pocket portion establishes a barrier between the fin and the heat exchanger plate for providing electrical isolation.

In a further non-limiting embodiment of any of the foregoing traction battery packs, the frame portion is received against a portion of a top surface of the heat exchanger plate that circumscribes the vent opening.

In a further non-limiting embodiment of any of the foregoing traction battery packs, a vent gas exit path extends beneath the heat exchanger plate.

In a further non-limiting embodiment of any of the foregoing traction battery packs, a battery cell compartment of the battery cell stack is fluidly connectable to the vent gas exit path via the vent opening.

In a further non-limiting embodiment of any of the foregoing traction battery packs, a first portion of the vent gas exit path extends between the heat exchanger plate and an enclosure tray of the traction battery pack.

In a further non-limiting embodiment of any of the foregoing traction battery packs, the heat exchanger plate is supported above a floor of the enclosure tray by a rib of the enclosure tray.

In a further non-limiting embodiment of any of the foregoing traction battery packs, a second portion of the vent gas exit path extends between a structural plate member of the traction battery pack and the heat exchanger plate.

In a further non-limiting embodiment of any of the foregoing traction battery packs, the structural plate member is arranged between the battery cell stack and a side wall of the enclosure tray.

In a further non-limiting embodiment of any of the foregoing traction battery packs, a third portion of the vent gas exit path extends between the structural plate member and the side wall of the enclosure tray.

In a further non-limiting embodiment of any of the foregoing traction battery packs, the first portion, the second portion, and the third portion of the vent gas exit path are fluidly connected to one another.

A traction battery pack according to another exemplary aspect of the present disclosure includes, among other things, an enclosure assembly including an enclosure tray, a heat exchanger plate positioned within the enclosure tray, a cell stack positioned against the heat exchanger plate, a structural plate member arranged between the cell stack and a side wall of the enclosure tray, and a vent gas exit path extending beneath the heat exchanger plate.

In a further non-limiting embodiment of the foregoing traction battery pack, a first portion of the vent gas exit path extends between the heat exchanger plate and the enclosure tray.

In a further non-limiting embodiment of either of the foregoing traction battery packs, a second portion of the vent gas exit path extends between the structural plate member and the heat exchanger plate.

In a further non-limiting embodiment of any of the foregoing traction battery packs, a third portion of the vent gas exit path extends between the structural plate member and the side wall of the enclosure tray.

In a further non-limiting embodiment of any of the foregoing traction battery packs, the heat exchanger plate includes a vent opening and a barrier sheet received within the vent opening.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a perspective view of select portions of the traction battery pack of FIG. 2.

FIG. 4 illustrates an exemplary heat exchanger plate of the traction battery pack of FIG. 2.

FIG. 5 is an exploded view of select portions of the heat exchanger plate of FIG. 3.

### DETAILED DESCRIPTION

This disclosure details vent path management concepts for traction battery packs. An exemplary traction battery pack may include a vent gas exit path that extends beneath a heat exchanger plate of the traction battery pack. During a battery thermal event, battery vent byproducts released by one or more battery cells of a cell stack of the traction battery pack may be directed through exposed openings of the heat exchanger plate and then into the vent gas exit path. The battery vent byproducts may flow away from high voltage components of the cell stack within the vent gas exit path prior to being expelled from the traction battery pack. The openings of the heat exchanger plate may be sealed by barrier sheets during normal battery operating conditions. These and other features are discussed in greater detail in the following paragraphs of this detailed description.

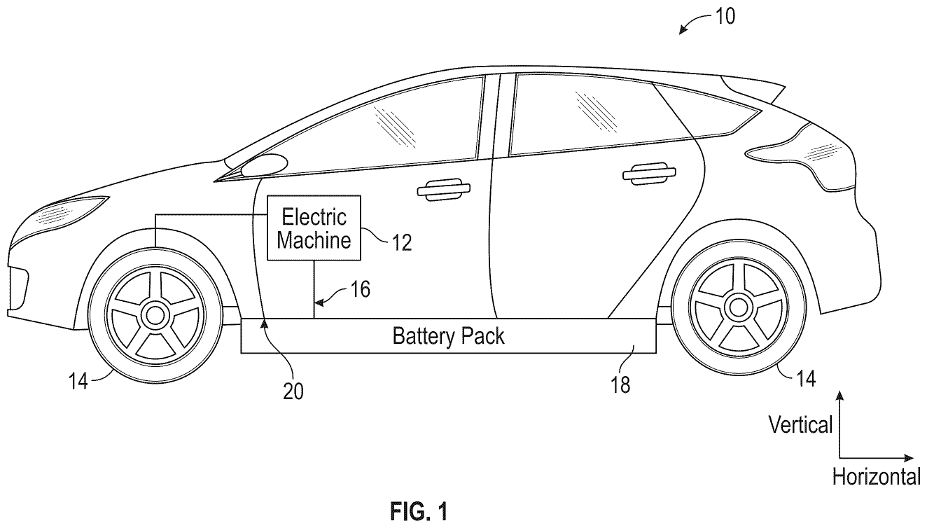

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

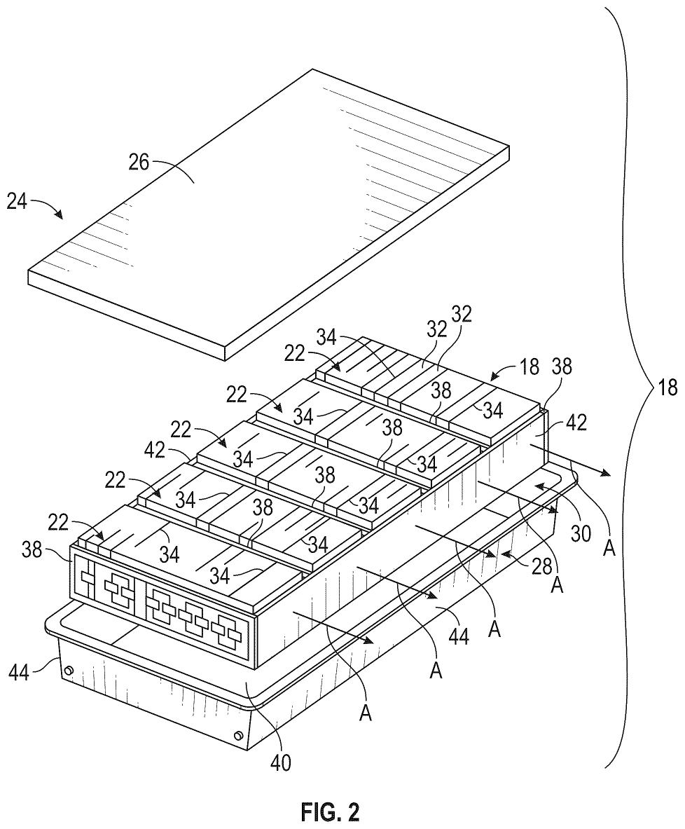

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of cell stacks 22 and battery cells 32 are illustrated in the various figures of this disclosure, the traction battery pack 18 could include any number of the cell stacks 22, with each cell stack 22 including any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The battery cells 32 can each include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

One or more thermal barrier assemblies 34 may be arranged along the respective cell stack axis A of each cell stack 22. The thermal barrier assemblies 34 may compartmentalize each cell stack 22 into two or more groupings or compartments.

The battery cells 32 and the thermal barrier assemblies 34 of each cell stack 22 may be arranged to extend laterally between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. Vertical and horizontal, for purposes of this disclosure, are with reference to ground and a general orientation of traction battery pack 18 when installed within the electrified vehicle 10 of FIG. 1. A coolant may be communicated inside the heat exchanger plate 40 for thermally managing the battery cells 32 of the cell stacks 22.

The traction battery pack 18 may additionally include a pair of structural plate members 42. One structural plate member 42 may be positioned between ends of the cell stacks 22 and each longitudinally extending side wall 44 of the enclosure tray 28, for example. The structural plate members 42 may extend along axes that are substantially transverse (e.g. perpendicular) to the cell stack axes A of the cell stacks 22 and to the cross-member assemblies 38. The structural plate members 42 can span across a majority of the length of the longitudinally extending side walls 44 of the enclosure tray 28 and are thus sometimes referred to as structural “megabars” of the traction battery pack 18. However, other configurations are contemplated within the scope of this disclosure.

In an embodiment, the cell stacks 22 and their respective cross-member assemblies 38 extend longitudinally in a cross-vehicle direction of the electrified vehicle 10, and the structural plate members 42 extend longitudinally in a length-wise direction of the electrified vehicle 10. However, other configurations are contemplated within the scope of this disclosure.

The structural plate members 42 may be secured to the cell stacks 22 for further structurally integrating the traction battery pack 18. For example, a plurality of fasteners (e.g., bolts or screws, not shown in FIG. 2) may be inserted through the structural plate members 42 and can be accommodated within fastener openings of the cross-member assemblies 38 for securing the structural plate members 42 to the cell stacks 22. These connections can help contain tensile loads that can occur over the life of the cell stacks 22 as a result of battery cell expansion forces, for example.

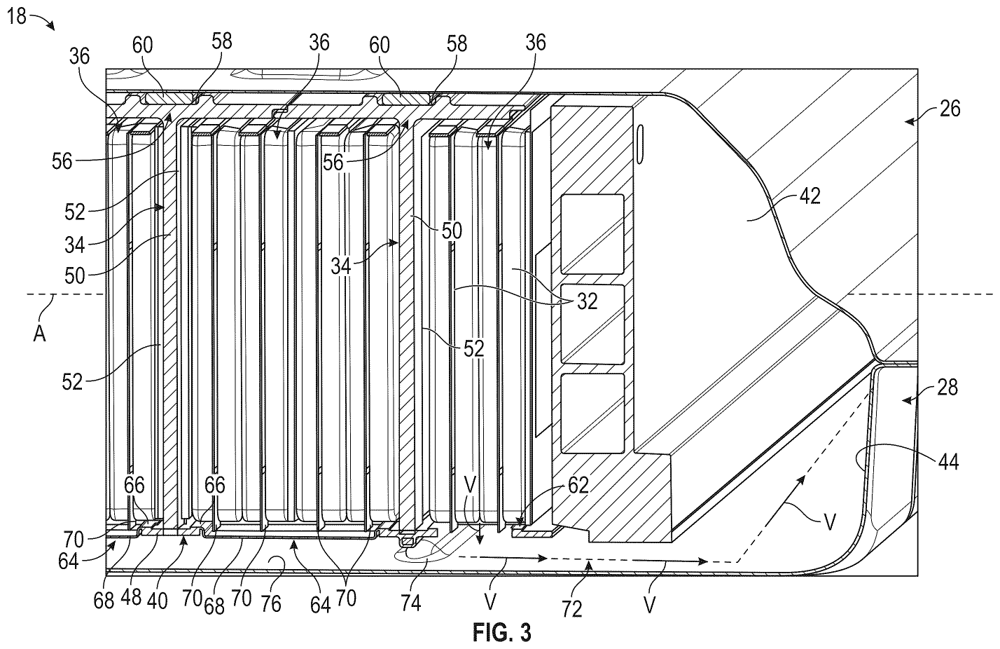

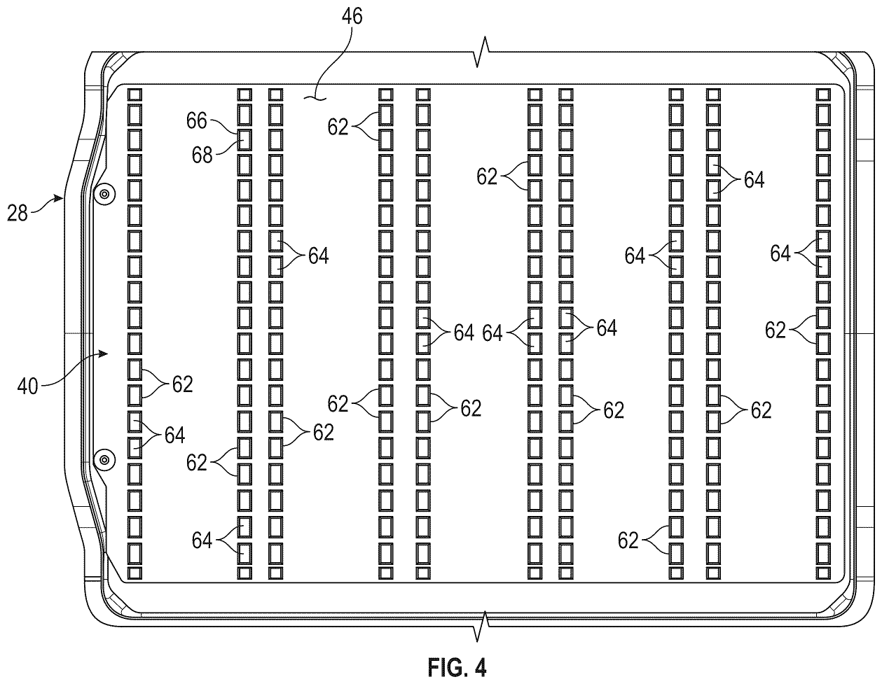

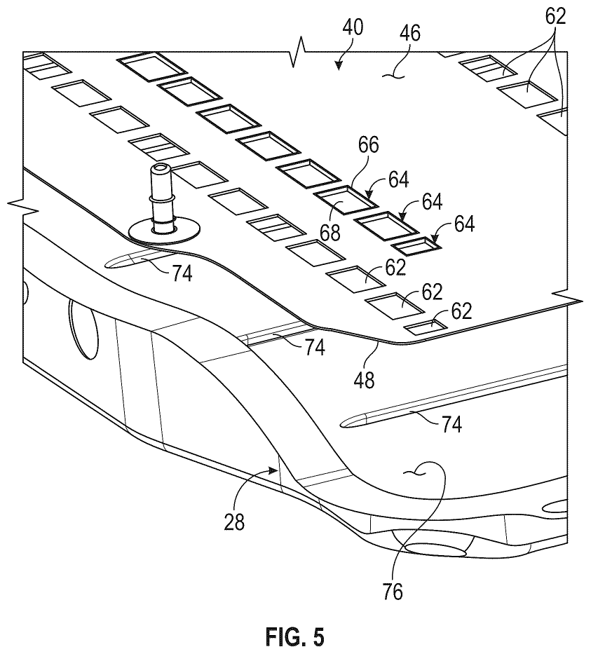

Referring now to FIGS. 3, 4, and 5, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more subgroupings or compartments 36 of battery cells 32. Each compartment 36 may hold one or more of the battery cells 32 of the cell stack 22.

Should, for example, a battery thermal event occur in one of the cell stacks 22, the thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18.

Each thermal barrier assembly 34 of the cell stack 22 may include a structural barrier 50 that is flanked by pairs of thermal resistance material layers 52 as part of a multi-layered structure of the thermal barrier assembly 34. The structural barrier 50 may be sandwiched between the thermal resistance material layers 52. The thermal resistance material layers 52 can be positioned in abutting contact with major side surfaces of battery cells 32 located in adjacent compartments 36 of the cell stack 22.

The structural barrier 50 may include a thermoplastic structure or a polymer composite structure (e.g., glass fiber reinforced polypropylene with an intumescent additive), for example, and the thermal resistance material layers 52 may include aerogel layers or mica sheets, for example. However, other materials or combinations of materials could be utilized to construct the subcomponents of the thermal barrier assembly 34 within the scope of this disclosure.

The structural barrier 50 of the thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The structural barrier 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the structural barrier 50. In other implementations, the structural barrier 50 could be an injection molded part or an extruded part.

Each thermal barrier assembly 34 may be configured to establish a sealed interface at the enclosure cover 26. For example, the structural barrier 50 of the thermal barrier assembly 34 may include an upper interfacing structure 56 that provides an upper plateau 58 for securing the thermal barrier assembly 34 to the enclosure cover 26, such as via an adhesive 60 (best shown in FIG. 3), for example. The adhesive 60 may be an epoxy based adhesive or a urethane based adhesive, for example. Once the upper interfacing structures 56 are secured relative to the enclosure cover 26, the thermal barrier assemblies 34 can substantially prevent thermal energy from moving from one compartment 36 to another at the sealed interface between each thermal barrier assembly 34 and the enclosure cover 26, such as during a battery thermal event, for example.

The heat exchanger plate 40 may include a plurality of vent openings 62. In an embodiment, each vent opening 62 is a through opening that is formed through the heat exchanger plate 40. The vent openings 62 therefore open through both a top surface 46 and a bottom surface 48 of the heat exchanger plate 40. Each vent opening 62 may establish a thermal break in the heat exchanger plate 40.

A barrier sheet 64 may be positioned within each vent opening 62 of the heat exchanger plate 40. The barrier sheets 64 may therefore seal the vent openings 62 for limiting the transfer of thermal energy from the cell stack 22 to the heat exchanger plate 40 and the enclosure tray 28 and for thermally isolating the compartments 36 from one another during normal operating conditions of the traction battery pack 18.

In an embodiment, the barrier sheets 64 are mica sheets. However, the barrier sheets 64 could be made of aerogel materials, refractory ceramic fibers, or other materials or combinations of materials that are capable of providing heat insulating properties.

Each barrier sheet 64 may include a frame portion 66 and a pocket portion 68. The frame portion 66 of each barrier sheet 64 may extend within a plane that is vertically higher than a floor of each pocket portion 68. When the barrier sheet 64 is arranged within one of the vent openings 62, the frame portion 66 may be received against a portion of the top surface 46 of the heat exchanger plate 40 that circumscribes the vent opening 62, and the pocket portion 68 may extend at least partially through the vent opening 62.

Each pocket portion 68 may accommodate one or more fins 70 of the battery cells 32 of the cell stack 22 (see, e.g., FIG. 3). The fins 70 may have a greater vertical (i.e., Z-axis) dimension compared to a main body of each battery cell 32. The pocket portions 68 establish barriers for preventing the fins 70 from contacting the heat exchanger plate 40, thereby providing electrical isolation.

The enclosure tray 28 may include a plurality of ribs 74 that protrude upwardly from a floor 76 of the enclosure tray 28. The ribs 74 may support the heat exchanger plate 40 above the floor 76 of the enclosure tray 28.

As best shown in FIG. 3, the traction battery pack 18 may further include a vent gas exit path 72 for expelling battery vent byproducts V from the traction battery pack 18 during a battery thermal event. For example, from time to time, pressure and thermal energy within at least one of the battery cells 32 of the cell stack 22 can increase. This can lead to the battery cell 32 discharging a flow of the battery vent byproducts V, which can include gas and debris. The battery vent byproducts V can be discharged from the battery cell 32 through a designated cell vent within a housing of the battery cell 32. The cell vent can be a membrane that yields in response to increased pressure and thermal energy within the battery cell 32. The cell vent can also be a ruptured area of the associated battery cell 32. Although a single one of the battery cells 32 is shown venting in FIG. 3, more than one of the battery cells 32 of the cell stack 22 can vent at the same time. The vent gas exit path 72 provides a path for the battery vent byproducts V to flow away from the battery cells 32 and then be purged from the traction battery pack 18.

A first portion of the vent gas exit path 72 may extend between the bottom surface 48 of the heat exchanger plate 40 and the enclosure tray 28. When exposed, the vent openings 62 of the heat exchanger plate 40 fluidly connect the compartments 36 of the cell stack 22 to the first portion of the vent gas exit path 72.

A second portion of the vent gas exit path 72 may extend between the one of the structural plate members 42 and the enclosure tray 28. The second portion of the vent gas exit path 72 may be fluidly connected to the first portion of the vent gas exit path 72.

A third portion of the vent gas exit path 72 may extend between the structural plate member 42 and the side wall 44 of the enclosure tray 28. The third portion of the vent gas exit path 72 may be fluidly connected to the second portion of the vent gas exit path 72.

During normal operating conditions of the traction battery pack 18, the barrier sheets 64 substantially seal the vent openings 62 of the heat exchanger plate 40 and thus fluidly isolate the compartments 36 of the cell stack 22 from the vent gas exit path 72.

During a battery thermal event in which one or more of the battery cells 32 of the cell stack 22 rupture and release battery vent byproducts V, the battery vent byproducts V may move against one or more of the barrier sheets 64 and cause the barrier sheet(s) 64 to become dislodged from the heat exchanger plate 40 or otherwise rupture or plastically deform, thereby exposing the vent opening 62 and permitting the flow of the battery vent byproducts V into the first portion of the vent gas exit path 72. The battery vent byproducts V can therefore be directed along a path that extends beneath the heat exchanger plate 40, thereby guiding the conductive gases away from high voltage connections of the cell stack 22.

Upon passing through the one or more vent openings 62, the battery vent byproducts V may flow through the vent gas exit path 72. The battery vent byproducts V may flow in a direction toward one of the structural plate members 42, for example, then flow under the structural plate member 42, and then flow between the structural plate member 42 and the side wall 44 of the enclosure tray 28. From here, the battery vent byproducts V may be expelled from the traction battery pack 18. Although not shown, the third portion of the vent gas exit path 72 may be fluidly connected to one or more of fluid manifolds, hoses, tubing, etc. for expelling the released battery vent byproducts V from the traction battery pack 18.

The exemplary traction battery packs of this disclosure provide vent gas exit paths that direct battery vent byproducts beneath a heat exchanger plate. By routing the battery vent byproducts beneath the heat exchanger plate, the battery vent byproducts can be isolated from internal high voltage buss bars and other electrical connections of the traction battery pack.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a battery cell stack;
a heat exchanger plate including a vent opening; and
a barrier sheet received within the vent opening,
wherein the barrier sheet is configured to dislodge from the vent opening or otherwise plastically deform and thereby expose the vent opening in response to a flow of a battery vent byproduct against the barrier sheet.

2. The traction battery pack as recited in claim 1, wherein the barrier sheet is a mica sheet.

3. The traction battery pack as recited in claim 1, wherein the barrier sheet includes a frame portion and a pocket portion.

4. The traction battery pack as recited in claim 3, wherein the frame portion extends within a plane that is vertically higher than a floor of the pocket portion.

5. The traction battery pack as recited in claim 4, wherein the pocket portion is sized to receive a fin of a battery cell of the battery cell stack.

6. The traction battery pack as recited in claim 5, wherein the pocket portion establishes a barrier between the fin and the heat exchanger plate for providing electrical isolation.

7. The traction battery pack as recited in claim 3, wherein the frame portion is received against a portion of a top surface of the heat exchanger plate that circumscribes the vent opening.

8. The traction battery pack as recited in claim 1, comprising a vent gas exit path extending beneath the heat exchanger plate.

9. The traction battery pack as recited in claim 8, wherein a battery cell compartment of the battery cell stack is fluidly connectable to the vent gas exit path via the vent opening.

10. The traction battery pack as recited in claim 8, wherein a first portion of the vent gas exit path extends between the heat exchanger plate and an enclosure tray of the traction battery pack.

11. The traction battery pack as recited in claim 10, wherein the heat exchanger plate is supported above a floor of the enclosure tray by a rib of the enclosure tray.

12. The traction battery pack as recited in claim 10, wherein a second portion of the vent gas exit path extends between a structural plate member of the traction battery pack and the heat exchanger plate.

13. The traction battery pack as recited in claim 12, wherein the structural plate member is arranged between the battery cell stack and a side wall of the enclosure tray.

14. The traction battery pack as recited in claim 13, wherein a third portion of the vent gas exit path extends between the structural plate member and the side wall of the enclosure tray.

15. The traction battery pack as recited in claim 14, wherein the first portion, the second portion, and the third portion of the vent gas exit path are fluidly connected to one another.

16. A traction battery pack, comprising:
an enclosure assembly including an enclosure tray;
a heat exchanger plate positioned within the enclosure tray;
a cell stack positioned against the heat exchanger plate;
a structural plate member arranged between the cell stack and a side wall of the enclosure tray; and
a vent gas exit path extending beneath the heat exchanger plate.

17. The traction battery pack as recited in claim 16, wherein a first portion of the vent gas exit path extends between the heat exchanger plate and the enclosure tray.

18. The traction battery pack as recited in claim 17, wherein a second portion of the vent gas exit path extends between the structural plate member and the heat exchanger plate.

19. The traction battery pack as recited in claim 18, wherein a third portion of the vent gas exit path extends between the structural plate member and the side wall of the enclosure tray.

20. The traction battery pack as recited in claim 16, wherein the heat exchanger plate includes a vent opening and a barrier sheet received within the vent opening.
